(19) United States
(12) Patent Application Publication
(10) Pub. No.: US 2026/0324667 A1
(43) Pub. Date: Oct. 22, 2026

(54) COLD BREW BEVERAGE SYSTEM AND METHODS FOR USE THEREOF

(71) Applicant: Southern Visions, LLP, Loxley, AL (US)

(72) Inventor: Adam Paul STEWART, Mobile, AL (US)

(73) Assignee: Southern Visions, LLP, Loxley, AL (US)

(21) Appl. No.: 19/486,261

(22) PCT Filed: May 22, 2024
(86) PCT No.: PCT/US2024/030573

§ 371 Date: Nov. 20, 2025

Related U.S. Application Data
(60) Provisional application No. 63/468,027, filed on May 22, 2023.

(51) Int. Cl. A23F 3/18; B65D 85/808

(52) U.S. Cl. CPC A23F 3/18; B65D 85/808

(57) ABSTRACT

A cold brew beverage product includes a water-permeable container (e.g., pouch) and a blend disposed in the water-permeable container. The blend includes a cold brew tea material and a solid sugar material. The blend may have less than or equal to about 30 weight % of the cold-brew tea material and greater than or equal to about 70 weight % of the solid sugar material based on a total weight of the blend. The cold brew tea material may be configured to steep in a liquid base having a temperature of less than or equal to about 50′° C. The solid sugar material may include particulates having particle sizes of greater than or equal to about U. S. 30 mesh sieve.

### CROSS-REFERENCE TO RELATED APPLICATIONS

This application claims the benefit of U.S. Provisional Application No. 63/468,027, filed on May 22, 2023. The entire disclosure of the above application is incorporated herein by reference.

### FIELD

The present disclosure relates to systems and methods for preparing cold brew beverages.

### BACKGROUND

Methods for preparing various beverage compositions, such as tea or coffee beverage compositions, often include heating or boiling water (for example, to greater than or equal to about 77 °C (about 170 F), contacting the heated water with a flavorant (including, for example, tea leaves, coffee grounds, or the like), and allowing the flavorant to steep within the heated water for a predetermined or selected time period. Hot steeping of tea is typically conducted at temperatures greater than about 79 °C (about 175 F) and often higher, for example, at or near boiling, depending on the type of tea. For example, green and white teas may be hot steeped at relatively lower temperatures of about 79 °C (about 175 F) to about 82 °C (about 180 F), oolong at somewhat higher temperatures of about 91 °C (about 195 F) to 93 °C (about 200 F), while black teas and pu-erh may be steeped in temperatures at or near boiling 96 °C (about 205 F) to about 100 °C (about 212 F).

To form a sweetened beverage, natural or artificial sweeteners are often added to beverage or water. The flavorant may be provided, with or without a sweetener, within a water permeable container or sieve. The sieve may be a porous filter, packet, or pouch, such as a tea bag. The flavorant and/or sweetener may be extracted and/or dissolved during the steeping. These brewing methods, including heating water to high temperatures, are often time-consuming, attention-demanding, and labor intensive. This is particularly true for iced beverages, where the liquid is first heated for hot steeping and then cooled afterwards for consumption, for example, typically to a temperature range of greater than or equal to about 0 °C (about 32 F) to less than or equal to about 16 °C (about 60 F).

Cold brew beverages, which eliminate the need for warming or boiling water, are growing in popularity. Regardless of the process (traditional hot brewing or cold brewing), beverage color and appearance is important to consumer's acceptability of such beverages. While cold brew beverages are helpful insofar as such processes eliminate the need to warm or boil the base liquid, it is often difficult to produce beverages that have similar color development and sweetness levels of hot brewed beverages. In particular, achieving the appropriate rates of dissolution of sweeteners can often be challenging at temperatures used in traditional cold brew methods. Generally, it is recognized that smaller granules or particles of sugar have a higher surface area and are capable of dissolving at a higher rate in cold liquid. Thus, conventionally smaller particle sizes of sugar are employed to sweeten cold brew beverages. For example, about one to two cups of extra fine granulated sugar may be added to one gallon of a beverage base (i.e., water). Dissolution may be partially expedited or aided, for example, by aggressive stirring, mixing or other agitation. Such steps, however, simply add to the complexity of the brewing process that use of cold-brew methods seek to reduce.

Batch-to-batch reproducibility and substantially complete dissolution of added sugar is important in making consistent and high-quality sweetened beverages as the level of sweetness is often a critical characteristic for consumer acceptance and approval. Neither insufficient sweetness nor excess sweetness is desirable, and while individual palates can reach different conclusions on this variable, Brix refractometer testing is often used as a quantifiable analytical test measurement for sweetness. Undissolved sweetener in a sweetened beverage not only indicates incomplete sweetening but may also leave an undesirable appearance. A clear, amber-colored appearance with minimal cloudiness is often desired by consumers.

There is a continuing need for reproducible, rapid, user-friendly systems and methods for the preparation of cold brew beverages, and in particular, sweetened cold brew beverages, including for at-home preparation, providing consistent flavor and color development profiles, including cold brew beverages having consistent color and sweetness.

### SUMMARY

This section provides a general summary of the disclosure and is not a comprehensive disclosure of its full scope or all of its features.

In various aspects, the present disclosure provides a cold brew beverage product.

In certain aspects, the cold brew beverage includes a water-permeable container and a blend disposed in the water-permeable container. The blend includes a cold brew tea material and a solid sugar material. The blend may have less than or equal to about 30 weight percent of the cold-brew tea material and greater than or equal to about 70 weight percent of the solid sugar material based on a total weight of the blend. The cold brew tea material may be configured to steep in a liquid base having a temperature of less than or equal to about 50 °C The solid sugar material may include particulates having particle sizes of greater than or equal to about U.S. 30 mesh sieve.

In certain aspects, the blend may fill greater than or equal to about 50 vol. percent of a total interior volume defined by the water-permeable container.

In certain aspects, the solid sugar material may be selected from the group consisting of: glucose, fructose, galactose, sucrose, lactose, maltose, and combinations thereof.

In certain aspects, the water-permeable container may have at least one dimension greater than or equal to about 15 millimeters.

In certain aspects, the water-permeable container may include a material selected from the group consisting of: nylon, polyester, polypropylene, polyethylene, polylactic acid, cotton, cellulose, and combinations thereof.

In certain aspects, the solid sugar material may be a first solid sugar material and the blend may further include a second solid sugar material. The second solid sugar material may include one or more of: (i) particulates having particle sizes greater than or equal to about U.S. 25 mesh sieve; (ii) particulates having particle sizes greater than or equal to about U.S. 20 mesh sieve; (iii) particulates having particle sizes greater than or equal to about U.S. 18 mesh sieve; (iv) particulates having particle sizes greater than or equal to about U.S. 16 mesh sieve; (v) particulates having particle sizes greater than or equal to about U.S. 14 mesh sieve; (vi) particulates having particle sizes greater than or equal to about U.S. 12 mesh sieve; (vii) particulates having particle sizes greater than or equal to about U.S. 10 mesh sieve; or (viii) particulates having particle sizes greater than or equal to about U.S. 8 mesh sieve.

In certain aspects, the blend may include greater than or equal to about 50 weight percent of the first solid sugar material based on the total weight of the blend and greater than or equal to about 50 weight percent of the second solid sugar material based on the total weight of the blend.

In certain aspects, the cold brew beverage product may consist of the water-permeable container and the blend, where the blend consists of the tea material and the solid sugar material and the solid sugar material consists of the particulates having particle sizes greater than or equal to about U.S. 30 mesh sieve.

In certain aspects, the cold brew beverage product may consist of the water-permeable container and the blend, where the blend consists of the tea material and the solid sugar material and (i) the solid sugar material consists of the particulates having particle sizes greater than or equal to about U.S. 25 mesh sieve, (ii) the solid sugar material consists of the particulates having particle sizes greater than or equal to about U.S. 20 mesh sieve, (iii) the solid sugar material consists of the particulates having particle sizes greater than or equal to about U.S. 18 mesh sieve, (iv) the solid sugar material consists of the particulates having particle sizes greater than or equal to about U.S. 16 mesh sieve, (v) the solid sugar material consists of the particulates having particle sizes greater than or equal to about U.S. 14 mesh sieve, (vi) the solid sugar material consists of the particulates having particle sizes greater than or equal to about U.S. 12 mesh sieve, (vii) the solid sugar material consists of the particulates having particle sizes greater than or equal to about U.S. 10 mesh sieve, or (viii) the solid sugar material consists of the particulates having particle sizes greater than or equal to about U.S. 8 mesh sieve.

In certain aspects, the cold brew tea material may include a tea powder and tea leaves.

In certain aspects, the cold brew tea material may include the tea powder at greater than or equal to 1 weight percent to less than or equal to about 10 weight percent with a balance being the tea leaves.

In certain aspects, the cold brew tea material may be configured to steep in the liquid base having a temperature of less than or equal to about 50 °C for less than or equal to about 20 minutes and form a cold brew beverage product having total dissolved solids of greater than or equal to about 200 parts per million and a Brix sugar content of greater than or equal to about 7.

In certain aspects, the blend may include less than or equal to about 20 weight % of the cold-brew tea material and greater than or equal to about 80 weight % of the solid sugar material based on a total weight of the blend.

In various aspects, the present disclosure provides a method for preparing a cold brew beverage.

In certain aspects, the method may include contacting a cold brew beverage product with a liquid base in a container having a temperature less than or equal to about 50 °C, where the cold brew beverage product includes a water-permeable container and a blend of a cold brew tea material and a solid sugar material. The blend may include less than or equal to about 30 weight percent of the tea material and greater than or equal to about 70 weight percent of the solid sugar material based on the total weight of the blend. The solid sugar materials may include sugar particulates having particle sizes greater than or equal to about U.S. 30 mesh sieve. The method may further include steeping the cold brew tea material in the liquid base in the container for a duration of less than or equal to about 25 minutes to form the cold brew beverage, where the cold brew beverage has total dissolved solids of greater than or equal to about 200 parts per million and a Brix sugar content of greater than or equal to about 7.

In certain aspects, the temperature may be greater than or equal to about 5 °C

In certain aspects, the cold brew beverage product may be freely disposed in the container.

In certain aspects, during the steeping, the cold brew beverage product may sink to the bottom of the container and subsequently rise to the top of the container as a portion of the solid sugar material dissolves in the liquid base.

In certain aspects, the contacting may include either disposing the cold brew beverage product and the liquid base in the container concurrently, disposing the cold brew beverage product in the container and subsequently introducing the liquid base into the container, or introducing the liquid base into the container and subsequently disposing the cold brew beverage product in the container.

In certain aspects, the duration may be greater than or equal to about 5 minutes to less than or equal to about 20 minutes.

In certain aspects, the temperature of the liquid base is not increased during the steeping.

In certain aspects, the cold brew beverage may have total dissolved solids of greater than or equal to about 400 parts per million and a Brix sugar content of greater than or equal to about 10.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view illustrating a cold brew beverage product including a of a tea material and a sugar material disposed in a water-permeable container (e.g., a packet or pouch) in accordance with various aspects of the present disclosure;

FIG. 2 is a flowchart illustrating an example method for preparing a cold brew beverage using a cold brew beverage product including a blend of a tea material and a sugar material disposed in a water-permeable container, for example as illustrated in FIG. 1, in accordance with various aspects of the present disclosure;

FIG. 3 is an illustration of the movement of a cold brew beverage product during steeping or formation of a cold brew beverage, for example using the method illustrated in FIG. 2, in accordance with various aspects of the present disclosure;

FIG. 4 is a flowchart illustrating another example method for preparing a cold brew beverage using a cold brew beverage product including a blend of a tea material and a sugar material disposed in a water-permeable container, for example as illustrated in FIG. 1, in accordance with various aspects of the present disclosure; and

FIG. 5 is an illustration of the movement of a cold brew beverage product during the steeping or formation of a cold brew beverage, for example using the method illustrated in FIG. 4, in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain variations, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Systems and methods for preparing cold brew beverages are provided by various aspects of the present disclosure. In particular, in certain variations, the cold brew beverage may be an iced tea or sweet tea. Traditional sweet tea includes a brewed tea base having added sweetener (such as natural sugars, sucrose, or other conventional sweeteners) and is typically served over ice.

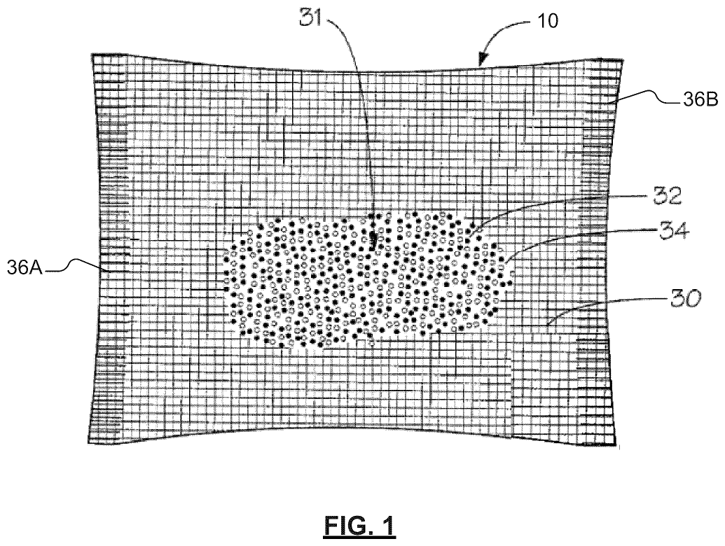

FIG. 1 illustrates a cold brew beverage product 10 for forming a cold brew beverage in accordance with certain aspects of the present disclosure. The cold brew beverage product 10 includes a water-permeable container, here in the form or a water-permeable pouch 30, where part of the water-permeable pouch 30 is a sealed container retaining a blend 31 of a tea material 32 and solid sugar material 34 (shown via cutaway of a region of the water-permeable material). The tea material 32 and the solid sugar material 34 may be a loose mixture distributed within the interior of the water-permeable pouch 30. The tea material 32 and the solid sugar material 34 are desirably mixed together. In certain aspects, the blend 31 may be homogenously mixed, although as will be appreciated by those of skill in the art, settling during processing, transport, and storage may occur such that the tea material 32 and solid sugar material 34 may remain mixed and distributed within the water-permeable pouch 30, albeit less evenly than when introduced into the water-permeable pouch 30. In certain aspects, the blend 31 of the tea material 32 and the solid sugar material 34 may fill greater than or equal to about 30 vol. percent, optionally greater than or equal to about 35 vol. percent, optionally greater than or equal to about 40 vol. percent, optionally greater than or equal to about 45 vol. percent, optionally greater than or equal to about 50 vol. percent, optionally greater than or equal to about 55 vol. percent, optionally greater than or equal to about 60 vol. percent, optionally greater than or equal to about 65 vol. percent, optionally greater than or equal to about 70 vol. percent, optionally greater than or equal to about 75 vol. percent, optionally greater than or equal to about 80 vol. percent, optionally greater than or equal to about 85 vol. percent, optionally greater than or equal to about 90 vol. percent, or in certain aspects, optionally greater than or equal to about 95 vol. percent, of a total interior volume defined by the interior of the sealed water-permeable pouch 30. In various aspects, the cold brew beverage product 10 may have a total weight less than or equal to about 24 ounces. For example, in certain aspects, the cold brew beverage product 10 may have a total weight greater than or equal to about 3.5 ounces to less than or equal to about 24 ounces, and optionally, greater than or equal to about 3.5 ounces to less than or equal to about 15 ounces.

In certain aspects, the blend 31 of tea material 32 and solid sugar material 34 may be referred to as a cold-brewable beverage composition. In certain aspects, the cold-brewable beverage composition may include less than or equal to about 30 weight percent, optionally less than or equal to about 25 weight percent, and in certain aspects, optionally less than or equal to about 20 weight percent of the tea material 32 of a total weight of blend 31. In certain aspects, the cold-brewable beverage composition may include less than or equal to about 15 weight percent, optionally less than or equal to about 12 weight percent, optionally less than or equal to about 10 weight percent, optionally less than or equal to about 9 weight percent, optionally less than or equal to about 8 weight percent, optionally less than or equal to about 7 weight percent, optionally less than or equal to about 6 weight percent, optionally less than or equal to about 5 weight percent, optionally less than or equal to about 4 weight percent, optionally less than or equal to about 3 weight percent, optionally less than or equal to about 2 weight percent, and in certain aspects, optionally less than or equal to about 1 weight percent, of the tea material 32 of a total weight of blend 31

In certain aspects, the cold-brewable beverage composition may include greater than or equal to about 70 weight percent, optionally greater than or equal to about 75 weight percent, and in certain aspects, optionally greater than or equal to about 80 weight percent, of the solid sugar material 34 of a total weight of blend 31. In certain aspects, the cold-brewable beverage composition may include greater than or equal to about 85 weight percent, optionally greater than or equal to about 90 weight percent, optionally greater than or equal to about 92 weight percent, optionally greater than or equal to about 94 weight percent, and in certain aspects, optionally greater than or equal to about 95 weight percent, of the solid sugar material 34 based on the total weight of the blend 31 composition.

The tea material 32 may include, for example, materials from tea plants (e.g., Camellia sinensis) including dried leaf teas, dried tea powders or extracts, or combinations thereof. The tea material 32 may include, for example, a cold brew tea. Cold brew teas are formulated to leach or steep in a liquid base that includes water that has a relatively low temperature, for example, well below typical hot brewing temperatures of greater than or equal to about 79 °C (about 175 F). Thus, cold brew teas are capable of steeping in a relatively short duration in a liquid base at relatively low temperatures, for example, at a temperature of less than or equal to about 50 °C (about 122 F) (for example, tap water typically has a temperature of about 7 °C (about 45° F) to about 13 °C (about 55 F)) in less than or equal to about 30 minutes and optionally less than or equal to about 20 minutes. The cold brew tea provides good color development and tea flavor when steeped in a low temperature liquid.

In certain aspects, the cold brew tea material 32 includes dried tea leaves as a component, which as used herein may include various materials or portions of the tea plant, including leaves, stems, or buds that are typically considered a tea leaf component, including partial or cut tea leaves, such as fragments or pieces of tea leaves. In certain aspects, the tea leaves may have an average size of greater than or equal to about 1 millimeter.

The cold brew tea material 32 may also include a tea powder, which may include ground and dried/dehydrated tea leaves (including buds, stems, and leaves), extracted tea powder where certain components of the tea plant are extracted via an extraction process, or combinations thereof. For example, the tea powder may include components from the tea plant, such as leaves, in milled form, comminuted form, particulate form, or any combination thereof. An average particle size of the tea powder may be less than or equal to about 500 micrometers, for example, less than or equal to about 400 micrometers, optionally less than or equal to about 300 micrometers, optionally less than or equal to about 250 micrometers, optionally less than or equal to about 200 micrometers, optionally less than or equal to about 100 micrometers, optionally less than or equal to about 75 micrometers, and in certain variations, optionally less than or equal to about 50 micrometers.

The cold brew tea material 32 may include tea powder at less than or equal to about 10 weight percent of the tea material 32 with a balance being the tea leaves (or tea leaf derived component), for example, at greater than or equal to about 90 weight percent. By way of example, the cold brew tea material 32 may include tea powder at greater than or equal to 1 weight percent to less than or equal to about 10 weight percent with greater than or equal to 90 weight percent to less than or equal to about 99 weight percent tea leaves, optionally greater than or equal to 2 weight percent to less than or equal to about 10 weight percent tea powder with greater than or equal to 90 weight percent to less than or equal to about 98 weight percent tea leaves, and in certain aspects, optionally greater than or equal to 5 weight percent to less than or equal to about 7 weight percent tea powder with greater than or equal to 93 weight percent to less than or equal to about 95 weight percent tea leaves.

In certain aspects, the tea material 32 may include materials having sizes retained by US 30 mesh size. In other alternative aspects, the tea material 32 may include materials having sizes retained by US 50 mesh size. In still other alternative aspects, the tea material 32 may include a first portion including materials having sizes retained by US 30 mesh size and a second portion including materials retained by US 50 mesh size. For example, a 4-ounce sample of the tea material 32 may include about 21.25 percent (or 0.85 ounces) retained by US 30 mesh size and about 62.5 percent (or 2.5 ounces) retained by US 50 mesh size. In still other alternative aspects, the tea material 32 may include a first portion including materials having sizes retained by US 30 mesh size, a second portion including materials retained by US 50 mesh size, and a third portion. For example, a four ounce sample of the tea material 32 may include about 21.25 percent (or 0.85 ounces) retained by US 30 mesh size, about 62.5 percent (or 2.5 ounces) retained by US 50 mesh size, and about 16.25 percent (0.65 ounces) defining the third portion.

Although the various examples provided herein provide tea materials, it should be appreciated that in alternative examples, the blend 31 may include one or more flavorants, in addition, or alternatively to, the tea material 32. For example, in certain variations, the blend 31 may include a dried or powderized concentrate, such as lemonade concentrate or other fruit juice concentrate, in addition to or in place of the tea material 32. As will be appreciated, where the concentrate powder substitutes for the tea material 32, some of the parameters discussed below pertinent to tea may no longer be applicable to the cold brew beverage.

Although not illustrated, it should be appreciated that, in various aspects, the cold brew beverage product 10 may further include one or more other flavorants, including, for example, natural or synthetic flavorants, including dried fruit, fruit extracts, fruit flavorants, or any combination thereof. In certain aspects, the one or more other flavorants may be blended with the tea material 32 and the solid sugar material 34 in the blend 31. In other alternative aspects, the one or more other flavorants may be coated on one or more interior or exterior surfaces of the water-permeable pouch 30.

The solid sugar material 34 may include naturally occurring, soluble carbohydrates typically found in, or sourced from, plants and plant components, but also present in mammalian milk and honey. For example, the solid sugar material 34 may include simple sugars, compound sugars, or a combination of simple sugars and compound sugars. The simple sugars may include, for example, monosaccharides, such as glucose, fructose, and galactose. The compound sugars may include, for example, disaccharides or double sugars, which are molecules made of two bonded monosaccharides. Disaccharides may include, for example, sucrose, lactose, maltose, or any combination thereof. Sucrose is a disaccharide of glucose and fructose. The solid sugar material 34 may be provided in particulate form. The particulates may take a variety of shapes, including one or more of spherical, non-spherical, cylindrical, square, rectangular, and the like. In certain aspects, the particulate form may include sugar agglomerates, which are categorized as pearls, pellets, clusters, assemblies, or aggregates of smaller forms the sugar.

It should be appreciated that, during refining processes, solid sugar material (like the solid sugar material 34) is often moved through a series of sieves having decreasing mesh apertures and rated accordingly with a U.S. mesh number to determine particle size. Using a U.S. mesh sieve number to quantify particle size is indicative of describing particulates that are retained by that sieve when a sample of varying particulates passed through. The smaller the U.S. mesh number, the larger the particle size of the sugar particulates, while the larger the mesh number, the smaller the particle size of the sugar particles. For example, a particulate sugar sample having a particle size of 18 U.S. mesh sieve has a particle size larger than the particle size of a particulate sugar sample with a particle size of 40 U.S. mesh. A particulate sugar sample having a particle size of 18 U.S. mesh sieve will generally include particles having varying particle sizes, all of which are sufficiently large to be retained by the 18 U.S. mesh sieve. The following table summarizes common sieve designations and the average size of their respective sieve openings.

TABLE 1
Particle Size Conversion Table

| Sieve Designation | | Nominal Sieve Opening | |
|---|---|---|---|
| Standard (mm) | Mesh | Inches | Millimeters |
| 25.4 | 1 | 1.00 | 25.4 |
| 22.6 | 7/8 | 0.875 | 22.6 |
| 19.0 | 3/4 | 0.750 | 19.0 |
| 16.0 | 5/8 | 0.625 | 16.0 |
| 13.5 | 0.530 | 0.530 | 13.5 |
| 12.7 | 1/2 | 0.500 | 12.7 |
| 11.2 | 7/16 | 0.438 | 11.2 |
| 9.51 | 3/8 | 0.375 | 9.51 |
| 8.00 | 5/16 | 0.312 | 8.00 |
| 6.73 | 0.265 | 0.265 | 6.73 |
| 6.35 | 1/4 | 0.250 | 6.35 |
| 5.66 | No. 3½ | 0.223 | 5.66 |
| 4.76 | No. 4 | 0.187 | 4.76 |
| 4.00 | No. 5 | 0.157 | 4.00 |
| 3.36 | No. 6 | 0.132 | 3.36 |
| 2.83 | No. 7 | 0.111 | 2.83 |
| 2.38 | No. 8 | 0.0937 | 2.38 |
| 2.00 | No. 10 | 0.0787 | 2.00 |
| 1.68 | No. 12 | 0.0661 | 1.68 |
| 1.41 | No. 14 | 0.0555 | 1.41 |
| 1.19 | No. 16 | 0.0469 | 1.19 |
| 1.00 | No. 18 | 0.0394 | 1.00 |
| 0.841 | No. 20 | 0.0331 | 0.841 |
| 0.707 | No. 25 | 0.0278 | 0.707 |
| 0.595 | No. 30 | 0.0234 | 0.595 |
| 0.500 | No. 35 | 0.0197 | 0.500 |
| 0.420 | No. 40 | 0.0165 | 0.420 |
| 0.354 | No. 45 | 0.0139 | 0.354 |
| 0.297 | No. 50 | 0.0117 | 0.297 |
| 0.250 | No. 60 | 0.0098 | 0.250 |
| 0.210 | No. 70 | 0.0083 | 0.210 |
| 0.177 | No. 80 | 0.0070 | 0.177 |
| 0.149 | No. 100 | 0.0059 | 0.149 |
| 0.125 | No. 120 | 0.0049 | 0.125 |
| 0.105 | No. 140 | 0.0041 | 0.105 |
| 0.088 | No. 170 | 0.0035 | 0.088 |
| 0.074 | No. 200 | 0.0029 | 0.074 |
| 0.063 | No. 230 | 0.0025 | 0.063 |
| 0.053 | No. 270 | 0.0021 | 0.053 |
| 0.044 | No. 325 | 0.0017 | 0.044 |
| 0.037 | No. 400 | 0.0015 | 0.037 |

Reviewing Table 1, it will be understood that particulate sugar sample having a particle size of 18 U.S. mesh sieve size would include particulates having particle sizes greater than or equal to 1 millimeter.

The solid sugar material 34 in the cold brew beverage product may include sugar particulates having relatively large particle sizes. In conjunction with the inventive activities, it was surprisingly and unexpectedly discovered that larger particle sized sugar could be successfully used in a cold brew beverage product, and in particular, a sweetened cold brew product, like sweet tea. Sugar is less soluble in colder water associated with cold brewing. Thus, it was previously believed that a large particle sized sugar particle having a low surface area would have dissolution rates in cooler water that were too low and thus would be incapable of forming a sweetened cold brew beverage. Stated in another way, it was generally believed that smaller granules or particles of sugar were necessary to adequately dissolve in a cold liquid due to having a higher surface area and higher dissolution rate in cooler temperatures. Conventionally, smaller particle sizes of sugar would be employed to sweeten cold brew beverages and would often require extensive stirring or agitation to dissolve and sweeten the beverage.

However, it was unexpectedly discovered that larger particle size sugar with a reduced surface area could create a fully sweetened cold brew beverage in a relatively short duration of time. First, cold brew beverage products with a water-permeable container having only tea material are observed to float at or near an air-water interface in the storage vessel. A cold brew tea material and solid sugar with smaller particle sizes has been observed to sink to, and remain at, a bottom of the container during typical steeping time durations. However, a cold brew beverage product with a water-permeable container having tea material and solid sugar with larger particle sizes prepared in accordance with the present disclosure behaves in a different manner when placed into a container having a cold temperature base liquid comprising water. The water-permeable container/pouch initially sinks to the bottom of the container, where the movement due to sinking exposes the water-permeable container/pouch to moving liquid/water. Then, the water-permeable container/pouch rests at or near the bottom of the container for a brief period of time where the larger sized solid sugar particles at least partially dissolve and establish a given sugar concentration in the surrounding base liquid at the bottom. As the larger-sized particles dissolve, water can enter the water-soluble container/pouch and fill in the gaps around the tea material to enhance steeping. After a sufficient amount of larger particle sized sugar is dissolved, the water-soluble container/pouch lightens and again becomes buoyant (as the weight of the solid sugar in the container is reduced) and the water-soluble container/pouch traverses the storage vessel/container from the bottom returning to the top at or near the air-liquid interface. Again, this movement through the base liquid exposes the water-soluble container to additional liquid having a lower concentration of sugar to promote additional dissolution of the sugar and additional steeping of the tea material.

At the top of the container, the concentration of sugar and tea in the liquid base is lower, which enhances the diffusion and dissolution of sugar and tea material. The ability of the cold brew water-permeable container/pouch to freely move and migrate, for example, from the top to bottom and back to the top of the storage vessel/container is unique to a water-soluble container/pouch having larger particle size solid sugar and unexpectedly provides relatively rapid dissolution of sugar into the base liquid while providing good color and flavor development of the tea material in a cold temperature liquid base.

With renewed reference to FIG. 1, in certain aspects, the solid sugar material 34 may include sugar particulates having relatively large particle sizes particle sizes. In certain aspects, the solid sugar material includes particulates having particles size of greater than or equal to U.S. 30 mesh sieve. That is, the solid sugar material 32 may include sugar particulates having particles sizes greater than or equal to approximately 0.6 millimeters. In alternative aspects, the solid sugar material includes particulates having particle sizes of greater than or equal to U.S. 25 mesh sieve. That is, the solid sugar material 34 may include sugar particulates having particle sizes greater than or equal to approximately 0.7 millimeters. In alternative aspects, the solid sugar material includes particulates having particle sizes of greater than or equal to U.S. 20 mesh sieve. That is, the solid sugar material 34 may include sugar particulates having particle sizes greater than or equal to approximately 0.8 millimeters. In alternative aspects, the solid sugar material includes particulates having particle sizes of greater than or equal to U.S. 18 mesh sieve. That is, the solid sugar material 34 may include sugar particulates having particle sizes greater than or equal to approximately 1 millimeters. In alternative aspects, the solid sugar material includes particulates having particle sizes of greater than or equal to U.S. 16 mesh sieve. That is, the solid sugar material 34 may include sugar particulates having particle sizes greater than or equal to approximately 1.2 millimeters. In alternative aspects, the solid sugar material 34 may include sugar particulates having particle sizes greater than or equal to U.S. 14 mesh sieve size. That is, the solid sugar material 34 may include sugar particulates having particle sizes greater than or equal to about 1.4 millimeters. In alternative aspects, the solid sugar material 34 may include sugar particulates having particle sizes greater than or equal to U.S. 12. That is, the solid-sugar material 34 may include sugar particulates having particles sizes greater than or equal to about 1.7 millimeters. In alternative aspects, the solid sugar material 34 may include sugar particulates having particles sizes greater than or equal to U.S. 10. That is, the solid-sugar material 34 may include sugar particulates having particles sizes greater than or equal to about 2 millimeters. In alternative aspects, the solid sugar material 34 may include sugar particulates having particles sizes greater than or equal to U.S. 8. That is, the solid-sugar material 34 may include sugar particulates having particles sizes greater than or equal to about 2.4 millimeters.

The particle size of the solid sugar material 34 may be variable. For example, in certain aspects, the solid sugar material 34 may include greater than or equal to about 50 weight percent, optionally greater than or equal to about 60 weight percent, optionally greater than or equal to about 70 weight percent, optionally greater than or equal to about 80 weight percent, optionally greater than or equal to about 85 weight percent, and in certain variations, optionally greater than or equal to about 90 weight percent, of particulate sugar based on a total weight of the solid sugar material 34 having particles sizes greater than or equal to about 16 U.S. mesh sieve and/or greater than or equal to about 50 weight percent, optionally greater than or equal to about 60 weight percent, optionally greater than or equal to about 70 weight percent, optionally greater than or equal to about 80 weight percent, optionally greater than or equal to about 85 weight percent, an in certain aspects, optionally greater than or equal to about 90 weight percent, of particulate sugar based on a total weight of the solid sugar material 34 having particles sizes greater than or equal to about 14 mesh sieve and/or greater than or equal to about 50 weight percent, optionally greater than or equal to about 60 weight percent, optionally greater than or equal to about 70 weight percent, optionally greater than or equal to about 80 weight percent, optionally greater than or equal to about 85 weight percent, and in certain variations, optionally greater than or equal to about 90 weight percent, of particulate sugar based on a total weight of the solid sugar material 34 having particles sizes greater than or equal to about 12 mesh sieve and/or greater than or equal to about 50 weight percent, optionally greater than or equal to about 60 weight percent, optionally greater than or equal to about 70 weight percent, optionally greater than or equal to about 80 weight percent, optionally greater than or equal to about 85 weight percent, and in certain variations, optionally greater than or equal to about 90 weight percent, of particulate sugar based on a total weight of the solid sugar material 34 having particles sizes greater than or equal to about 10 mesh sieve and/or greater than or equal to about 50 weight percent, optionally greater than or equal to about 60 weight percent, optionally greater than or equal to about 70 weight percent, optionally greater than or equal to about 80 weight percent, optionally greater than or equal to about 85 weight percent, an in certain aspects, optionally greater than or equal to about 90 weight percent, of particulate sugar based on a total weight of the solid sugar material 34 having particles sizes greater than or equal to about 8 mesh sieve.

The water-permeable pouch 30 may take a variety of forms and sizes depending on intended use (including, for example, volume of a beverage base). As illustrated, the water-permeable pouch 30 may have a general rectangular pouch shape, including one or more sealed edges 36A, 36B. Although a rectangular pouch shape is illustrated, it should be appreciated that, in various aspects, the water-permeable pouch 30 may take a variety of configurations, including, for example, square, triangular, circular, and the like. Although two sealed edges are illustrated, it should be appreciated that, in various aspects, the water-permeable pouch 30 may have one or more sealed edges. For example, in certain aspects, the water-permeable pouch 30 may be formed from a continuous sheet that is filled and joined along one or more edges to define the pouch structure. In other alternative aspects, the water-permeable pouch 30 may be formed from two or more distinct sheets that are aligned, filled, and joined along two or more edges to define the pouch structure.

The water-permeable pouch 30 may include a permeable fabric or membrane material. The water-permeable pouch 30 may include a natural material or a polymeric material. For example, in certain aspects, the water-permeable pouch 30 may include nylon, polyester, polypropylene, polyethylene, polylactic acid, cotton, cellulose, or any combination thereof in a woven or non-woven configuration. In each instance, the water-permeable pouch 30 may have a mesh size or porosity that is sufficient to retain the tea particles 32 and the sugar particulates 34 while permitting water molecules of a beverage base to penetrate the water-permeable pouch 30 and interact with the tea particles 32 and solid sugar particulates 34. In certain aspects, an average diameter of the plurality of pores of the water-permeable pouch 30 may be greater than or equal to about 50 micrometers to less than or equal to about 300 micrometers.

Although the water-permeable pouch 30 is illustrated as having a single compartment, it should be appreciated that, in alternative aspects, the water-permeable pouch 30 may include two or more compartments, where each of the two or more compartments includes a blend 31 of the tea particles 32 and the sugar particulates 34. As detailed below, the blend 31 of the tea particles 32 and sugar particulates 34 mixed together facilitates movement of water-permeable pouches, like the water-permeable pouch 30, through a beverage base.

In various aspects, the present disclosure provides a system of arrangement that includes a cold brew beverage product (including a tea material and a solid sugar material, like the cold brew beverage product 10 illustrated in FIG. 1) and a storage vessel/container configured to receive a liquid beverage base volume and the product. In certain aspects, the container may be a disposable product, for example, a single-use product. In certain aspects, the container may be a collapsible product, such as a flexible pouch. In certain variations, the container may be a single serve container that may be configured to receive less than or equal to about 40 fluid ounces of the liquid beverage base or other amount appropriate for a single serving. In other variations, the container may be multi-serving container that may be optionally less than 2 gallons or 3 gallons, for example, the container/storage vessel may be configured to receive greater than or equal to about 12 fluid ounces to less than or equal to about 128 fluid ounces, and in certain aspects, optionally greater than or equal to about 32 fluid ounces to less than or equal to about 128 fluid ounces, of the liquid beverage base. Although the container is described herein as being configured to receive one single cold brew beverage product, it should be appreciated that, in certain variations, the multiple cold brew beverage products (e.g., two or more containers/pouches) may be added to a liquid beverage base within the container. It will also be appreciated that in other variations, the cold brew beverage product may be used to form a concentrate with a reduced volume of liquid base that may later be blended with additional liquid beverage base to form the cold brew beverage product.

In certain aspects, the cold brew beverage product may be freely disposed within the container, meaning it is free to float and sink in the liquid base. In other alternative aspects, the cold brew beverage product may be fixedly or removably coupled to one or more exterior or interior surfaces of the container. For example, the container (and/or water-soluble pouch) may include one or more structures or accessories (including, for example, tethers, strings, apertures, pre-formed hooks, bendable members, clamps, adhesive members, or a combination thereof) that are configured to secure the cold brew beverage product. In certain aspects, the container may be a glass or plastic pitcher. In certain aspects, the liquid beverage base (also referred to as liquid base) may include water. For example, the liquid beverage base may include greater than or equal to about 95 weight percent of water. In certain aspects, the liquid beverage base may be a flavored liquid beverage base including one or more flavorants dissolved, dispersed, or suspended in water.

In various aspects, the present disclosure provides methods for preparing a cold brew beverage using a cold brew beverage product, including a tea material and a solid sugar material, like the cold brew beverage product 10 illustrated in FIG. 1. In certain variations, the methods may include contacting a cold brew beverage product with a liquid base in a container having a temperature less than or equal to about 50 °C (about 122 F). The cold brew beverage product may include a tea material and a solid sugar material, like the product 10 illustrated in FIG. 1. The method includes steeping the cold brew tea material in the liquid base in the container for a duration of less than or equal to about 30 minutes, optionally less than or equal to about 25 minutes, optionally less than or equal to about 20 minutes, optionally less than or equal to about 15 minutes, and in certain variations, optionally less than or equal to about 15 minutes. In this manner, the steeping forms the cold brew beverage. Total dissolved solids (TDS) generally can measure an amount of leached or steeped compounds transferred from the tea material into the liquid base, so that a higher TDS generally corresponds to higher flavor and color development for a tea beverage. As will be appreciated, water has a baseline TDS value depending on the source from which it is obtained, such that a measured TDS after cold brewing the tea may be relative depending on the baseline TDS of the water or liquid base. In certain aspects, the liquid beverage base after the steeping process for the predetermined duration may have a total dissolved solids (TDS) of greater than or equal to about 200 parts per million, optionally greater than or equal to about 250 parts per million, optionally greater than or equal to about 275 parts per million, optionally greater than or equal to about 300 parts per million, optionally greater than or equal to about 325 parts per million, optionally greater than or equal to about 350 parts per million, optionally greater than or equal to about 375 parts per million, optionally greater than or equal to about 400 parts per million, and in certain variations, optionally greater than or equal to about 425 parts per million.

As will be described further below, a sweetened beverage may be characterized by its sweetness level, which may be measured or quantified by Brix. Brix is a measure (degree) of the sugar content of an aqueous solution and is traditionally used in tea, wine, sugar, fruit juice, and honey industries to measure sweetness. One degree Brix generally correlates to one gram of dissolved sugar (e.g., sucrose, a disaccharide of fructose and glucose) in 100 grams of solution and represents the strength of the solution as a percentage by weight (% w/w). In certain aspects, the liquid beverage base after the steeping process for the predetermined duration may be considered to be sweetened and thus have a Brix sugar content of greater than or equal to about 7, optionally greater than or equal to about 7.2, optionally greater than or equal to about 7.4, optionally greater than or equal to about 7.5, optionally greater than or equal to about 7.6, optionally greater than or equal to about 7.8, optionally greater than or equal to about 8, optionally greater than or equal to about 8.5, optionally greater than or equal to about 9, optionally greater than or equal to about 9.5, optionally greater than or equal to about 10, optionally greater than or equal to about 10.5, optionally greater than or equal to about 10.8, optionally greater than or equal to about 11, optionally greater than or equal to about 11.5, optionally greater than or equal to about 12, optionally greater than or equal to about 12.5, optionally greater than or equal to about 13, optionally greater than or equal to about 13.5, and in certain variations, optionally greater than or equal to about 14.

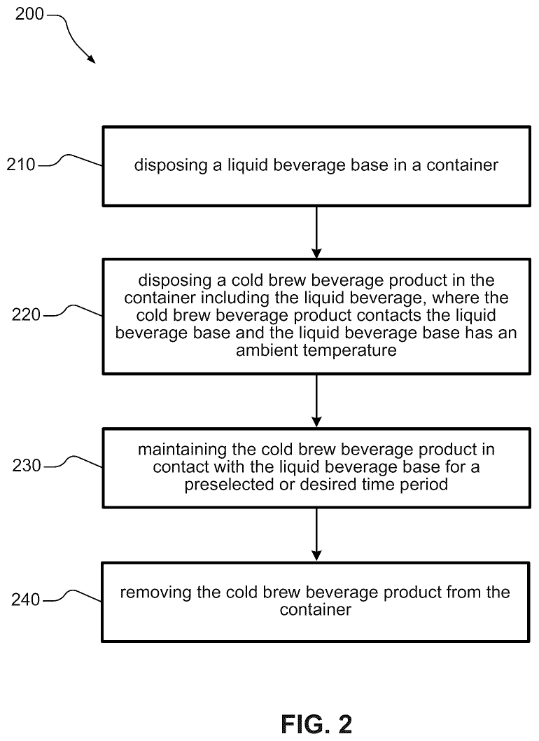

FIG. 2 illustrates an example method 200 for preparing a cold brew beverage using a cold brew beverage product including a tea material and a solid sugar material, like the product 10 illustrated in FIG. 1. As illustrated, the method 200 may include contacting the cold brew beverage product with the liquid base by disposing 220 (for example, placing, introducing) the cold brew beverage product in a container, including a liquid beverage base, where the cold brew beverage product contacts the liquid beverage base and the liquid beverage base has a relatively low temperature, for example, less than or equal to about 50 °C (about 122 F), optionally less than or equal to about 25 °C (about 77 F), which may correspond to ambient conditions that typically range from about 18 °C (about 64 F) to about 25 °C (about 77 F), and in certain variations, optionally less than or equal to about 13 °C (about 55 F), which may correspond to tap water conditions that typically range from about 7 °C (about 45 F) to about 13 °C (about 55 °F). The liquid base may further include solids, such as ice cubes, distributed therein.

In certain aspects, as noted above, the cold brew beverage product may be freely disposed within the container, such that it can move in the liquid base. In other alternative aspects, as noted above, the cold brew beverage product may be fixedly or removably coupled to one or more exterior or interior surfaces of the container. The container may be a glass or plastic pitcher.

An ambient temperature includes room temperature (e.g., greater than or equal to about 18 °C (about 64 F) to less than or equal to about 25 °C (about 77 F) or a temperature as source, such as a tap or facet as sourced from a public water system or well, or a temperature as purposefully cooled, such as by using refrigeration or ice.

In certain aspects, an ambient temperature of the liquid beverage base may be less than or equal to about 49 °C (about 120 F), optionally less than or equal to about 43 °C (about 110 F), optionally less than or equal to about 38 °C (about 100 F), optionally less than or equal to about 32 °C (about 90 F), optionally less than or equal to about 29 °C (85 about ° F), optionally less than or equal to about 27 °C (about 80 F), optionally less than or equal to about 24 °C (about 75 F), optionally less than or equal to about 21 °C (about 70 F), optionally less than or equal to about 21 °C (about 69 F), optionally less or equal to than about 20 °C (about 68 F), optionally less than or equal to about 19 °C (about 67 F), optionally less than or equal to about 18 °C (about 64 F), optionally less than or equal to about 17 °C (about 63 F), optionally less than or equal to about 16 °C (about 61 F), optionally less than or equal to about 15 °C (about 59 F), optionally less than or equal to about 14 °C (about 57 F), optionally less than or equal to about 13 °C (about 55 F), optionally less than or equal to about 12 °C (about 54 F), optionally less than or equal to about 11 °C (about 52 F), or in certain aspects, optionally less than or equal to about 10 °C (about 50 F).

In certain aspects, a temperature of the liquid beverage base may be greater than 0 °C (about 32 F) to less than or equal to about 49 °C (about 120 F), optionally greater than or equal to about 1 °C (about 34 F) to less than or equal to about 49 °C (about 120 F), optionally greater than or equal to about 2 °C (about 36 F) to less than or equal to about 49 °C (about 120 F), optionally greater than or equal to about 3 °C (about 37 F) to less than or equal to about 49 °C (about 120 F), optionally greater than or equal to about 4 °C (about 39 F) to less than or equal to about 49 °C (about 120 F), optionally greater than or equal to about 5 °C (about 40 F) to less than or equal to about 49 °C (about 120 F), optionally greater than or equal to about 5 °C (about 40 F) to less than or equal to about 49 °C (about 120 F), optionally greater than or equal to about 10 °C (about 50 F) to less than or equal to about 38 °C (about 100 F), optionally greater than or equal to about 13 °C (about 55 F) to less than or equal to about 27 °C (about 80 F), optionally greater than or equal to about 13 °C (about 55 F) to less than or equal to about 24 °C (about 75 F), optionally greater than or equal to about 13 °C (about 55 F) to less than or equal to about 21 °C (about 70 F), optionally greater than or equal to about 13 °C (about 55 F) to less than or equal to about 21 °C (about 69 F), an in certain variations, optionally greater than or equal to about 13 °C (about 55 F) to less than or equal to about 20 °C (about 68 F).

In certain aspects, the container may have a volumetric capacity that holds greater than or equal to about 946 milliliters (32 fluid ounces) to less than or equal to about 3,785 milliliters (128 fluid ounces) of the liquid beverage base. In one variation, the container may have a volumetric capacity so that it holds about a half-gallon of liquid beverage base (e.g., about 1,893 milliliters (about 64 fluid ounces)) or a gallon of liquid beverage base (e.g., about 3,785 ml (about 128 fluid ounces)). Liquid beverage base as included herein refers to a liquid component. It should be understood, however, that, in certain variations, the liquid beverage base may include, for example, solids like ice materials, which may further melt and thus change the amount of liquid beverage base present.

In certain aspects, the volume of the liquid beverage base may be adjusted in response to a preselected or desired sweetness of the cold brew beverage. For example, more of the liquid beverage base may be added when less sweetness is preselected or desired, and conversely, less of the liquid beverage base may be added when more sweetness is preselected or desired. Although not illustrated, it should be appreciated that, in various aspects, the method 200 may include selecting or determining a sweetness level and adjusting an amount of the liquid beverage base in the container.

In certain aspects, the method 200 may include introducing or disposing 210 the liquid beverage base into the container. As noted above, the liquid beverage base may include water. For example, the liquid beverage base may include greater than or equal to about 95 weight percent of water. In certain aspects, the liquid beverage base may be a flavored liquid beverage base including one or more flavorants dissolved, dispersed, or suspended in water.

In certain aspects, the method 200 may include steeping the cold brew beverage product, for example, by maintaining 230 the cold brew beverage product in contact with the liquid beverage base for a preselected or desired period, without any purposefully applied heat or heat energy. In certain aspects, the preselected or desired period may be determined in response to a preselected or desired sweetness of the cold brew beverage. For example, when less sweetness is preselected or desired, the cold brew beverage product may be maintained in the liquid beverage base for a shorter time period, and conversely, when more sweetness is preselected or desired, the cold brew beverage product may be maintained in the liquid beverage base for a longer time period. In certain aspects, the time period for maintaining 230 the cold brew beverage product in contact with the liquid beverage base may be greater than or equal to about 5 minutes to less than or equal to about 30 minutes, optionally greater than or equal to about 5 minutes to less than or equal to about 25 minutes, optionally greater than or equal to about 5 minutes to less than or equal to about 20 minutes, optionally greater than or equal to about 8 minutes to less than or equal to about 15 minutes, or optionally greater than or equal to about 8 minutes to less than or equal to about 12 minutes. Although not illustrated, it should be appreciated that, in various aspects, the method 200 may include selecting or determining a sweetness level and adjusting the time period accordingly.

In certain aspects, the method 200 may include removing the cold brew beverage product from the container. Although not illustrated, it should be appreciated that, in various aspects, the method may include characterizing the cold brew beverage. In certain aspects, Brix may be used to characterize the sweetness of the cold brew beverage. In certain aspects, the cold brew beverage prepared using the method 200 may be considered to be a sweetened beverage having Brix level like those described above, for example, at least greater than or equal to about 7.

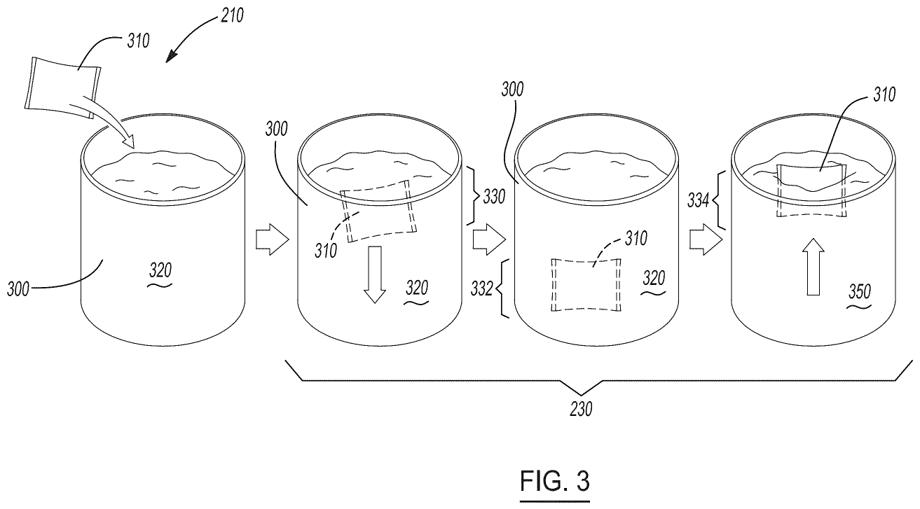

As illustrated in FIG. 3, during the formation of a cold brew beverage 350 (for example using the method 200 illustrated in FIG. 2) a cold brew beverage product 310 including a blend of a tea material and a sugar material disposed in a water-permeable pouch (for example like the cold brew beverage product 10 illustrated in FIG. 1) that may have variable buoyancy and may migrate from a first position 330 at or near or in the vicinity of a top of a liquid beverage base 320 volume held by the storage vessel/container to a second position 332 at or near or in the vicinity of a bottom of the liquid beverage base 320 volume to a third position 334 at or near or in the vicinity of the top of the cold brew beverage 350. The first position 330 is adjacent to an air-liquid interface in the container, while the second position 322 is adjacent to a solid-liquid interface in the container. In certain aspects, the third position 334 may be the same as the first position 330.

The movement of the cold brew beverage product 310 is understood to be a result of the dissolution and diffusion/transfer of the solid sugar material of the cold brew beverage product 310 by the liquid beverage base 320. As the solid sugar material of the cold brew beverage product 310 is absorbed by the liquid beverage base 320, pockets or openings are created within the tea material contained in the cold brew beverage product 310, allowing the liquid beverage base 320 to better infiltrate the cold brew beverage product 310 through the water-permeable housing of the pouch. As discussed above and detailed further in the examples below, the improved infiltration of liquid reduces the necessary time of maintaining the cold brew beverage product 310 in contact with the liquid beverage base 320 to form the cold brew beverage 350. Also as detailed further in the examples below, the improved infiltration also improves the final color and flavor development of the cold brew beverage 350 during the shortened maintenance period. The cold brew beverage product 310 may be removed from the liquid beverage base 320 prior to serving or consumption of the cold brew beverage 350.

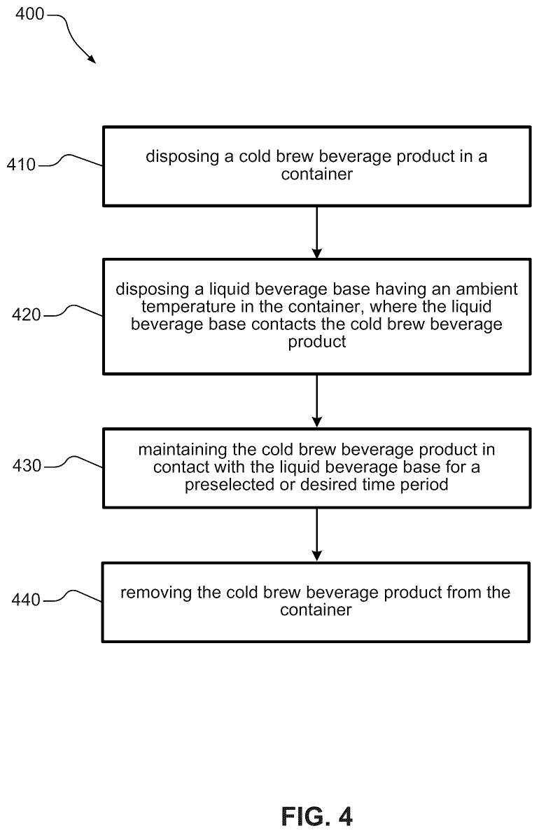

FIG. 4 illustrates another example method 400 for preparing a cold brew beverage using a cold brew beverage product including a tea material and a solid sugar material, like the cold brew beverage product 10 illustrated in FIG. 1. For brevity, the aspects and details of method 200 that are the same as method 400 in FIG. 4 will not be repeated herein unless otherwise relevant but will be understood to be fully applicable here. As illustrated, the method 400 may include disposing 410 (for example, placing, introducing) the cold brew beverage product in a container and subsequently or concurrently disposing a liquid beverage base having a relatively cold temperature, for example, an ambient temperature in the container such that the liquid beverage base contacts the cold brew beverage product. As with the embodiments described above, the cold brew beverage product may be freely disposed within the container or alternatively, fixedly or removably coupled to one or more exterior or interior surfaces of the container. Similarly, the container may be configured to receive greater the same amounts of liquid beverage base described above in the context of FIG. 2.

In certain aspects, the method 400 may include steeping, for example, maintaining 430 the cold brew beverage product in contact with the liquid beverage base for a preselected or desired period, without any purposefully applied heat or heat energy. In certain aspects, the preselected or desired period may be determined in response to a preselected or desired sweetness of the cold brew beverage. For example, when less sweetness is preselected or desired, the cold brew beverage product may be maintained in the liquid beverage base for a smaller time period, and conversely, when more sweetness is preselected or desired, the cold brew beverage product may be maintained in the liquid beverage base for a larger time period. In certain aspects, the time period for maintaining 430 the cold brew beverage product in contact with the liquid beverage base may be greater than or equal to about 5 minutes to less than or equal to about 20 minutes (e.g., greater than or equal to about 8 minutes to less than or equal to about 15 minutes or greater than or equal to about 8 minutes to less than or equal to about 12 minutes). Although not illustrated, it should be appreciated that, in various aspects, the method 400 may include selecting or determining a sweetness level and adjusting the time period accordingly.

In certain aspects, the method 400 may include removing the cold brew beverage product from the container. Although not illustrated, it should be appreciated that, in various aspects, the method may include characterizing the cold brew beverage. In certain aspects, the same Brix levels may be obtained as described above in the context of FIG. 2.

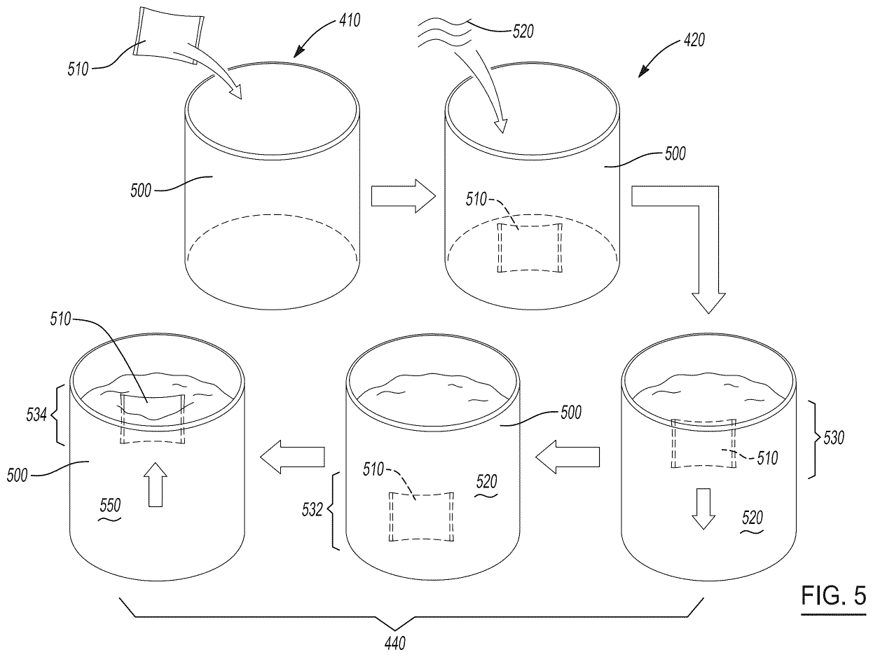

As illustrated in FIG. 5, during the formation of a cold brew beverage 550 (for example using the method 400 illustrated in FIG. 4) a cold brew beverage product 510 including a blend of a tea material and a sugar material disposed in a water-permeable pouch (for example like the product 10 illustrated in FIG. 1) may have variable buoyancy. The concepts described in the context of FIG. 3 are also applicable to those in FIG. 5. The water-permeable pouch 510 may migrate from a first position 530 at or near or in a vicinity of a top of a liquid beverage base 520 volume held by the container to a second position 532 at or near or in a vicinity of a bottom of the liquid beverage base 520 volume to a third position 534 at or near or in a vicinity of the top of the cold brew beverage 550. In certain aspects, the third position 534 may be the same as the first position 530. The movement of the cold brew beverage product 510 is understood to be a result of the dissolution and diffusion/transfer of the solid sugar material of the cold brew beverage product 510 by the liquid beverage base 520. As the solid sugar material of the cold brew beverage product 510 is absorbed by the liquid beverage base 520 pockets or openings are created within the tea material contained in the cold brew beverage product 510 allowing the liquid beverage base 520 to better infiltrate the cold brew beverage product 510 through the water-permeable housing of the pouch. As discussed above and detailed further in the examples below, the improved infiltration reduces the necessary time of maintaining the cold brew beverage product 510 in contact with the liquid beverage base 520 to form the cold brew beverage 550. Also as detailed further in the examples below, the improved infiltration also improves the final color and flavor development of the cold brew beverage 550 during the shorten maintenance period. The cold brew beverage product 510 may be removed from the liquid beverage base 520 prior to serving or consumption of the cold brew beverage 550.

The method of the present disclosure consistently produces a uniform amount of deliciously sweet beverage without heating of the liquid beverage base such as for example by application of flame (such as with a gas stove), contact with a heating surface (such as with a glass, ceramic or metallic coil electric cooking surface), or radiant energy (such as for example microwave energy or solar energy). The placing step and/or the maintaining steeping step are performed in the absence of purposefully applied heat or heat energy.

In various aspects, the methods of the present disclosure achieve efficient and effective dissolution of particulate sugar in conjunction with forming a sweetened beverage with high levels of flavor development. For example, in certain variations, less than or equal to about 35 weight percent, optionally less than or equal to about 30 weight percent, optionally less than or equal to about 25 weight percent, optionally less than or equal to about 20 weight percent, optionally less than or equal to about 15 weight percent, optionally less than or equal to about 10 weight percent, and in certain variations, optionally less than or equal to about 5 weight percent, of an initial amount of particulate sugar may remain in the water-permeable container after the steeping duration/beverage forming period.

In various aspects, the methods of the present disclosure provide an ability to consistently produces a uniform sweetened beverage using a liquid beverage base at low steeping temperatures that are typically at or below tea base temperatures that substantially correspond to, or may be lower than, typical temperatures for water sourced from a public water system or well and dispensed through a building plumbing system and tap, at the relatively low temperatures specified above. In certain variations, the liquid beverage base temperature does not substantially increase, for example, only increasing in temperature during the steeping process less than or equal to about 2.8 °C (about 5 F), optionally less than or equal to about 1.7 °C (about 3 F), and in certain variations, optionally less than or equal to about 1.1 °C (about 2 F). In certain variations, the liquid beverage base temperature increases, if at all, no more than about 2.8 °C (about 5 F) during the beverage forming period or throughout the method. It is notable that liquid beverage base temperatures correspond to common temperatures for water dispensed straight from a typical tap or similar source as well as water that may have been chilled by placement in a refrigerator or by adding ice, or which may contain some ice.

In various aspects, the methods of the present disclosure consistently produce a uniform sweetened beverage in an efficient and conveniently short period of time, as described above.

In various aspects, the liquid beverage base may be a volume of liquid beverage base contained within a containment vessel/container. The containment vessel may include a containment vessel bottom. During at least a portion of the duration of steeping/beverage forming period, the cold brew beverage product (e.g., water-permeable container/pouch) may migrate from various positions within the volume of liquid beverage base or containment vessel, for example from a first position to a second position to optional additional positions in the volume of liquid beverage base or containment vessel. As described above, one position may be nearer to the containment vessel bottom than a subsequent position, for example, near a top of the containment vessel.

In various aspects, for example, when the system includes a steeping vessel attachment accessory, the liquid beverage base may be contained within or held by or held in a containment vessel. The containment vessel may include a containment vessel bottom. The system may be removably attached to the containment vessel and suspended in the liquid beverage base during at least a portion of the beverage forming period. In at least one example embodiment, the containment vessel may include a vessel wall and a rim and the containment vessel attachment accessory may engage with the containment vessel rim.

As set forth above, one of ordinary skill will understand and appreciate that elements or features used to describe one aspect or embodiment may be applicable and useful in describing other aspects or embodiments. Accordingly, descriptions and disclosure relating to elements or features of an aspect or embodiment of the present disclosure are hereby expressly relied on to describe and support those elements or features in other aspects or embodiments. More specifically, descriptions and disclosure relating to elements or features of the aspect of the present disclosure as described herein and relating to a cold brew beverage product or system for making or manufacturing a sweetened beverage are hereby expressly relied on to describe and support those elements or features in the method aspects of the present disclosure, and vice versa. In both examples, all description and disclosures relating to the liquid beverage base and water-permeable container/pouch as set forth in the system aspect are expressly relied on to describe and support those elements in all other aspects, including method aspects.

Certain features of the current technology are further illustrated in the following examples.

### Example 1

Various samples of particulate sugar were prepared. The particulate sugar samples were prepared by passing a sugar material comprising sugar particles through a series of mesh sieve sizes (e.g., stacked) having decreasing mesh apertures (for example, as rated according to a U.S. number) to determine, or confirm, particle sizes. As the sugar material was passed through the series of sieves, sugar material with larger particle sizes was retained by preceding sieves and remaining sugar material passed through to the next sieve, where a target sieve in the stack retains particles having sizes greater than a desired particle size (percentage (%) retained) and allows particles having smaller particles to pass through (percentage (%) passing). The sugar material collected from the target sieve (i.e., percent retained by the target sieve) was categorized as having on average a greater particles size than a target particle size matching the mesh size of the target sieve and defined a particular sugar sample.

A control sample was prepared by passing a conventional extra fine granulated sugar (EFG) through a series of sieves (e.g., U.S. mesh/sieve sizes 18, 25, 35, 50, 80, 100, and 120) to determine particle size. TABLE 2 summarizes the amount of extra fine granulated sugar retained by each sieve.

TABLE 2
Control Sample Particle Size Confirmation

| Mesh/Sugar | Amount | % of Total |
|---|---|---|
| Particle Size | Retained | Weight |
| US 18 | 0.05 oz | 1% |
| US 25 | 0.2 oz | 3% |
| US 35 | 1.45 oz | 24% |
| US 50 | 2.75 oz | 46% |
| US 80 | 1.05 oz | 18% |
| US 100 | 0.15 oz | 3% |
| US 120 | 0.1 oz | 2% |
| Catch | 0.25 oz | 4% |
| Total Weight | 6 oz | — |

The extra fine granulated sugar is calculated to have an average particle size corresponding to what would be a theoretical 53 mesh sieve (falling between a 50 and 60 standard mesh size) in an individual mesh pouch. The average particle size was determined by dividing the amount of the total sample weight minus the small amount retained in the catch to determine a weight fraction, multiplying the weight fraction by the retaining sieve size to determine a particle size fraction, and adding the individual particle size fractions to obtain the average particle size.

The particulate sugar samples were added to individual mesh pouches that were sealed to form sample water-permeable pouches. The control sample was similarly added to an individual mesh pouch that was sealed to form a control water-permeable pouches. In each instance, the mesh pouches were square pouches that were 15.24 millimeters (6 inches) by 15.24 millimeters (6 inches) and formed from nonwoven polylactic acid fabrics. Each individual water-permeable pouch included 7.25 ounces of respective sugar material and 1 ounce of tea material.

The individual water-permeable pouches were freely placed in respective beverage containers/storage vessels. The respective beverage containers were cylindrical pitchers. The respective beverage containers were filled with 1760 milliliters (59.5 fluid ounces) of a liquid beverage base (e.g., water) having a temperature of about 18.9 °C (about 66 F) reflecting an example of a cold brew liquid temperature. The individual water-permeable pouches maintained contact with the respective beverage bases for a total of about 40 minutes. Upon removal of the individual water-permeable pouches from contact with the beverage base at about 40 minutes, Brix values were obtained for the beverage base using a commercially available Brix refractometer. A final beverage base temperature was also taken. There was about a 2-degree temperature decrease noted for each sample. The individual water permeable pouches were also briefly removed from contact with the respective beverage base at about 10 minutes, about 20 minutes, about 25 minutes, about 30 minutes, and about 35 minutes to test the Brix values (sucrose content) in the base liquid for the respective samples. The base liquid was briefly and gently stirred before the Brix values were obtained and subsequent contact between the water permeable pouches and the respective beverage base. The Brix values for the different particulate sugar samples and also the control sample for Example 1 are summarized below in TABLE 3. Notably, a Brix value of 10.8 indicates complete dissolution of 7.25 ounces of sugar in 1760 milliliters (59.5 fluid ounces) of water.

TABLE 3
Example 1: Brix Levels Sugar Pouch Testing Data,
Direct Placement

| Average | | | | | | |
|---|---|---|---|---|---|---|
| Sugar | | | | | | |
| Particle | 10 min. | 20 min. | 25 min. | 30 min. | 35 min. | 40 min. |
| Size | (Brix) | (Brix) | (Brix) | (Brix) | (Brix) | (Brix) |
| 12.7 mm | 7.4 | 10 | 10.4 | 10.8 | 10.8 | 10.8 |
| 9.51 mm | 8 | 10 | 10.4 | 10.8 | 10.8 | 10.8 |
| 8 mm | 8 | 10 | 10.6 | 10.8 | 10.8 | 10.8 |
| US 4 | 7.2 | 10.2 | 10.6 | 10.8 | 10.8 | 10.8 |
| US 8 | 7.8 | 10.2 | 10.6 | 10.8 | 10.8 | 10.8 |
| US 10 | 7.8 | 10.6 | 10.8 | 10.8 | 10.8 | 10.8 |
| US 12 | 7.8 | 10.4 | 10.6 | 10.8 | 10.8 | 10.8 |
| US 14 | 6 | 10 | 10.4 | 10.6 | 10.8 | 10.8 |
| US 16 | 6 | 9 | 10 | 10.2 | 10.4 | 10.6 |
| US 18 | 5 | 7.8 | 8.6 | 9 | 9.6 | 10 |
| US 20 | 5.4 | 7 | 7.6 | 8 | 8.6 | 9 |
| US 25 | 4 | 5.6 | 6.6 | 6.8 | 7.2 | 7.8 |
| US 30 | 4.4 | 6 | 6.4 | 6.8 | 7.2 | 7.8 |
| US 35 | 4 | 5 | 5.8 | 6.2 | 6.8 | 7.2 |
| Control | 2.6 | 4.2 | 5 | 5.6 | 6.2 | 6.6 |

As illustrated in Table 3 above, the samples including generally larger particle sizes (and therefore smaller surface areas) surprisingly experience faster dissolution, as well as more general dissolution, and those samples having particles sizes corresponding with particles retained by US 8, particle sizes corresponding with sugar particulates retained by US 10, and particles sizes corresponding with sugar particulates retained by US 12 experience the fastest and greatest dissolution. Notably, the control never nears complete dissolution (e.g., 10.8 Brix) even after 40 minutes.

### Example 2

Certain samples were prepared as noted above in the instance of Example 1, however, the individual water-permeable pouches in this example were hung from the respective beverage containers. More particularly, the water-permeable pouches may include a filament (e.g., plastic filament) that is received by a hook or like structure (e.g., plastic hook) of (or connected to) the respective beverage container/storage vessel. The Brix values for the different particulate sugar samples and also the control sample for Example 2 are summarized below in TABLE 4.

TABLE 4
Example 2: Sugar Pouch Testing Data, Hanging Placement

| Average | | | | | | |
|---|---|---|---|---|---|---|
| Sugar | | | | | | |
| Particle | 10 min. | 20 min. | 25 min. | 30 min. | 35 min. | 40 min. |
| Size | (Brix) | (Brix) | (Brix) | (Brix) | (Brix) | (Brix) |
| 12.7 mm | 9 | 10.2 | 10.8 | 10.8 | 10.8 | 10.8 |
| 9.51 mm | 9 | 10.4 | 10.8 | 10.8 | 10.8 | 10.8 |
| 8 mm | 9 | 10.4 | 10.8 | 10.8 | 10.8 | 10.8 |
| US 4 | 9 | 10.8 | 10.8 | 10.8 | 10.8 | 10.8 |
| US 8 | 9 | 10.8 | 10.8 | 10.8 | 10.8 | 10.8 |
| US 10 | 9.8 | 10.6 | 10.8 | 10.8 | 10.8 | 10.8 |
| US 12 | 9.6 | 10.6 | 10.6 | 10.8 | 10.8 | 10.8 |
| US 14 | 9.4 | 10.6 | 10.6 | 10.8 | 10.8 | 10.8 |
| US 16 | 8 | 10.2 | 10.4 | 10.8 | 10.8 | 10.8 |
| US 18 | 7.2 | 9 | 9.6 | 10.2 | 10.6 | 10.8 |
| US 20 | 5 | 6.8 | 7.6 | 8.4 | 8.8 | 9.4 |
| US 25 | 3.6 | 5.2 | 6 | 6.8 | 7 | 7.6 |
| US 30 | 3.4 | 5 | 5.4 | 6.2 | 6.8 | 7.2 |
| US 35 | 3.2 | 4.6 | 5.2 | 6 | 6.4 | 7 |
| Control | 2.6 | 4 | 4.8 | 5.4 | 6 | 6.4 |

As illustrated in Table 4 above, the samples including generally larger particle sizes (and therefore smaller surface areas) surprisingly experience faster dissolution, as well as more general dissolution, and those samples having particles sizes corresponding with particles retained by US 10, particle sizes corresponding with sugar particulates retained by US 12, and particles sizes corresponding with sugar particulates retained by US 14 experience the fastest and most dissolution.

### Example 3

Certain samples were prepared as noted above in the instance of Example 1, however, each of the individual water-permeable pouches in this instance further include 0.5 ounces of cold brew tea leaves (as removed from commercially available LIPTON® Cold Brew Ice Black Tea) mixed with the particulate sugar sample or the control (extra fine granulated sugar) sample. The Brix values for the different particulate sugar samples and also the control sample for Example 3 are summarized below in TABLE 5.

TABLE 5
Example 3: Sugar and Tea Pouch Testing Data, Direct Placement

| Average | | | | | | |
|---|---|---|---|---|---|---|
| Sugar | | | | | | |
| Particle | 10 min. | 20 min. | 25 min. | 30 min. | 35 min. | 40 min. |
| Size | (Brix) | (Brix) | (Brix) | (Brix) | (Brix) | (Brix) |
| 12.7 mm | 7.4 | 10 | 10.6 | 10.8 | 10.8 | 10.8 |
| 9.51 mm | 7.6 | 10 | 10.6 | 10.8 | 10.8 | 10.8 |
| 8 mm | 7.2 | 10.2 | 10.8 | 10.8 | 10.8 | 10.8 |
| US 4 | 6.6 | 10.2 | 10.8 | 10.8 | 10.8 | 10.8 |
| US 8 | 6.2 | 10.2 | 10.8 | 10.8 | 10.8 | 10.8 |
| US 10 | 8.8 | 10.6 | 10.8 | 10.8 | 10.8 | 10.8 |
| US 12 | 9.2 | 10.6 | 10.8 | 10.8 | 10.8 | 10.8 |
| US 14 | 9 | 10.2 | 10.8 | 10.8 | 10.8 | 10.8 |
| US 16 | 8.6 | 10.2 | 10.8 | 10.8 | 10.8 | 10.8 |
| US 18 | 7 | 8.4 | 9.2 | 9.6 | 10.2 | 10.4 |
| US 20 | 6.2 | 7.8 | 8.8 | 9.2 | 9.8 | 10.2 |
| US 25 | 5.6 | 7 | 8 | 8.6 | 9.4 | 9.8 |
| US 30 | 5.2 | 7 | 8 | 8.6 | 9.2 | 9.6 |
| US 35 | 4.6 | 6.4 | 7 | 7.6 | 8 | 8.4 |
| Control | 3.6 | 5.4 | 6 | 6.6 | 7 | 7.6 |

As illustrated in Table 5 above, the samples including generally larger particle sizes (and therefore smaller surface areas) surprisingly experience faster dissolution, as well as more general dissolution, and those samples having particles sizes corresponding with particles retained by US 10, particle sizes corresponding with sugar particulates retained by US 12, particles sizes corresponding with sugar particulates retained by US 14, and particle sizes corresponding with sugar particulates retained by US 16 experience the fastest and most dissolution. Further, as illustrated by comparing Table 3 and Table 5 above, in certain instances, the samples including the blend of the tea material and the sugar material surprisingly experiences faster dissolution than the sample including only the sugar material.

### Example 4

Certain samples were prepared as noted above in the instance of Example 2, however, each of the individual water-permeable pouches in this example further include 0.5 ounces of cold brew tea leaves (as removed from commercially available LIPTON® Cold Brew Ice Black Tea) mixed with the particulate sugar sample or the extra fine granulated sugar. The Brix values for the different particulate sugar samples and also the control sample for Example 4 are summarized below in TABLE 6.

TABLE 6
Example 4: Sugar and Tea Pouch Testing Data, Hanging Placement

| Average | | | | | | |
|---|---|---|---|---|---|---|
| Sugar | | | | | | |
| Particle | 10 min. | 20 min. | 25 min. | 30 min. | 35 min. | 40 min. |
| Size | (Brix) | (Brix) | (Brix) | (Brix) | (Brix) | (Brix) |
| 12.7 mm | 8.2 | 10.2 | 10.8 | 10.8 | 10.8 | 10.8 |
| 9.51 mm | 8.6 | 10.6 | 10.8 | 10.8 | 10.8 | 10.8 |
| 8 mm | 9 | 10.4 | 10.8 | 10.8 | 10.8 | 10.8 |
| US 4 | 9 | 10.8 | 10.8 | 10.8 | 10.8 | 10.8 |
| US 8 | 8.8 | 10.6 | 10.8 | 10.8 | 0.8 | 10.8 |
| US 10 | 8.8 | 10.6 | 10.8 | 10.8 | 10.8 | 10.8 |
| US 12 | 9.2 | 10.4 | 10.6 | 10.8 | 10.8 | 10.8 |
| US 14 | 9 | 9.8 | 10.2 | 10.4 | 10.6 | 10.8 |
| US 16 | 8.4 | 9.4 | 10 | 10.2 | 10.4 | 10.6 |
| US 18 | 6.8 | 8 | 8.6 | 9.2 | 9.6 | 10 |
| US 20 | 5.2 | 7.2 | 7.8 | 8.4 | 8.8 | 9 |
| US 25 | 4.2 | 6 | 6.8 | 7.6 | 8 | 8.4 |
| US 30 | 4.8 | 6.2 | 6.6 | 7.4 | 7.8 | 8.2 |
| US 35 | 4.2 | 5.4 | 6.2 | 7 | 7.4 | 7.6 |
| Control | 3.2 | 5 | 5.4 | 6 | 6.6 | 6.8 |

As illustrated in the above table, the samples including generally larger particle sizes (and therefore smaller surface areas) surprisingly experience faster dissolution, as well as more general dissolution, and those samples having particles sizes corresponding with particles retained by 8 mm, particle sizes corresponding with sugar particulates retained by US 4 mesh size, particles sizes corresponding with sugar particulates retained by US 8 mesh size, particle sizes corresponding with sugar particulates retained by US 10, particle sizes corresponding with sugar particles retained by US 12 mesh size, and particles sizes corresponding with sugar particles retained by US 14 mesh size experience the fastest and most dissolution.

### Example 5

Certain samples were prepared as noted above in the instance of Example 1, however, each of the individual water-permeable pouches in this example includes a mixture of sugars. For example, as summarized below in TABLE 7, a first sample may include 75 weight percent of sugar particulates retained by US 10 mesh size and 25 weight percent of extra fine granulated sugar for a total sugar content of 7.25 ounces, a second sample may include 50 weight percent of sugar particulates retained by US 10 mesh size and 50 weight percent of extra fine granulated sugar for a total sugar content of 7.25 ounces, a third sample may include 50 weight percent of sugar particulates retained by US 3.5 mesh size and 50 weight percent of sugar particulates retained by US 18 mesh size for a total sugar content of 7.25 ounces, and a fourth sample may include 50 weight percent of sugar particulates retained by US 3.5 and 50 weight percent of extra fine granulated sugar for a total sugar content of 7.25 ounces. An average particle size for the different samples may be calculated by multiplying the weight fraction of the particle size for each component and adding the products.

TABLE 7
Example 5: Sugar Pouch Testing Data
for Mixed Sugars, Direct Placement

| | Sugar Content | Sugar Content | Sugar Content | Sugar Content |
|---|---|---|---|---|
| | 75 % of US 10 | 50% of US 10 | 50 % of US 3.5 | 50% of US 3.5 |
| | 25 % of EFG | 50% of EFG | 50% of US 18 | 50% of EFG |
| Time | (Brix) | (Brix) | (Brix) | (Brix) |
| 10 mins | 6 | 4 | 6 | 3.8 |
| 20 mins | 9.8 | 7.2 | 9 | 5.6 |
| 25 mins | 10.6 | 8.4 | 10 | 6.4 |
| 30 mins | 10.8 | 9.6 | 10.4 | 7.6 |
| 35 mins | 10.8 | 10.2 | 10.6 | 8 |
| 40 mins | 10.8 | 10.6 | 10.8 | 8.6 |

As illustrated in Table 7, those samples including generally larger particle sizes (and therefore smaller surface areas) surprisingly experience faster dissolution, as well as more generally dissolution, and that sample including more of the sugar particulates retained by US 10 mesh size experience the fastest and most dissolution.

### Example 6

Certain samples were prepared as noted above in the instance of Example 1, however, the individual water-permeable pouches in this example were freely disposed in about 1774.4 milliliters (60 fluid ounces) of a liquid beverage base having a temperature of 21.11 °C (70 °F) and each individual water-permeable pouch included 6 ounces of respective sugar material and 1 ounce of cold brew tea material. The Total Dissolved Solids (TDS) amount was assessed for the different particulate sugar samples and also the control sample for Example 6 are summarized below in Table 8. Higher TDS values indicate a greater amount of leached or steeped compounds transferred from the tea material in the water-permeable pouch to the liquid base, generally corresponding to higher flavor and color development. The Brix values for the different particulate sugar samples and also the control sample for Example 6 are also summarized below in Table 8. The color values for the different particulate sugar samples and also the control sample for Example 6, as measured using a honey color portable photometer (i.e., HIANNA® Instruments Honey Color Portable Photometer HI96785), are also summarized below in Table 8.

TABLE 8
6 oz of Sugar Material, 1 oz of Cold Brew Tea Material

| Average | | | | | | |
|---|---|---|---|---|---|---|
| Sugar | Total Dissolved | | | | | |
| Particle | Solids (ppm) | | Brix | | Color | |
| Size | 8 min. | 12 min. | 8 min. | 12 min. | 8 min. | 12 min. |
| 9.51 mm | 339 | 408 | 7 | 9 | 56 | 82 |
| 8 mm | 404 | 420 | 7.6 | 9.6 | 76 | 83 |
| US 3.5 | 408 | 425 | 6 | 8.6 | 73 | 82 |
| US 12 | 355 | 413 | 9.6 | 10.6 | 78 | 84 |
| US 16 | 333 | 395 | 9.6 | 10.6 | 67 | 79 |
| US 20 | 304 | 355 | 8 | 9 | 57 | 77 |
| US 25 | 266 | 296 | 6 | 7.2 | 46 | 54 |
| US 30 | 233 | 267 | 5.4 | 6.6 | 41 | 51 |
| US 35 | 208 | 244 | 4.6 | 6 | 36 | 46 |
| Control | 204 | 251 | 3.2 | 5 | 33 | 43 |

As illustrated in Table 8 above, the samples including generally larger particle sizes (and therefore smaller surface areas) surprisingly experience faster dissolution, as well as move general dissolution, and further, those same samples including generally larger particle sizes (and therefore smaller surface areas) experience improved color numbers as well. Thus, generally the color development, amount of leached/steeped compounds removed from the cold brew tea material, and dissolved sugar in the beverage increases as the particle size of sugar included in the water-permeable container/pouch increases, contrary to previous expectations.

### Example 7

Certain samples were prepared as noted above in the instance of Example 1, however, the individual water-permeable pouches in this example were freely disposed in about 1774.4 milliliters (60 fluid ounces) of a liquid beverage base having a temperature of 22.22 °C (72 °F) and each individual water-permeable pouch included 4.5 ounces of respective sugar and 1 ounce of cold brew tea. The Total Dissolved Solids amount for the different particulate sugar samples and also the control sample for Example 7 are summarized below in Table 9. The Brix values for the different particulate sugar samples and also the control sample for Example 7 are also summarized below in Table 9. The color values for the different particulate sugar samples and also the control sample for Example 7, as measured using a honey color portable photometer (i.e., HANNA® Instruments Honey Color Portable Photometer HI96785), are also summarized below in Table 9.

TABLE 9
4.5 oz of Sugar Material, 1 oz of Tea Material

| Average | | | | | | |
|---|---|---|---|---|---|---|
| Sugar | Total Dissolved | | | | | |
| Particle | Solids (ppm) | | Brix | | Color | |
| Size | 5 min. | 8 min. | 5 min. | 8 min. | 5 min. | 8 min. |
| 9.51 mm | 416 | 464 | 4.5 | 5.9 | 76 | 85 |
| 8 mm | 387 | 437 | 4.6 | 6.1 | 59 | 77 |
| US 3.5 | 418 | 473 | 4.2 | 5.7 | 75 | 84 |
| US 12 | 372 | 421 | 7.2 | 7.4 | 70 | 77 |
| US 16 | 369 | 419 | 6.7 | 6.8 | 75 | 79 |
| US 20 | 345 | 420 | 6.7 | 7.1 | 64 | 78 |
| US 25 | 320 | 394 | 5.7 | 6.5 | 49 | 75 |
| US 30 | 281 | 335 | 4.3 | 5.7 | 42 | 65 |
| US 35 | 210 | 254 | 4 | 4.8 | 37 | 43 |
| Control | 160 | 215 | 2.7 | 4.2 | 28 | 37 |

As illustrated in the above table, the samples including generally larger particle sizes (and therefore smaller surface areas) surprisingly experience faster dissolution, as well as move general dissolution, and further, those same samples including generally larger particle sizes (and therefore smaller surface areas) experience improved color numbers as well. Again, the color development, amount of leached/steeped compounds removed from the cold brew tea material, and dissolved sugar in the beverage generally increases as the particle size of sugar included in the water-permeable container/pouch increases, contrary to previous expectations.

### Example 8

Comparative examples were prepared including cold brew tea alone, pea gravel, tapioca, extra fine granulated sugar, and rice to assess comparative alternative materials to large particle size sugar for a cold brew product system. A first comparative example includes 1 ounce of cold brew tea material in 1774.4 milliliters (60 ounces) of a liquid beverage base having a temperature of 21.11 °C (70 F), representative of a cold brew temperature. A second comparative example includes 2.30 ounces of pea gravel and 1 ounce of cold brew tea material in 44 milliliters of the liquid beverage base having a temperature of 21.11 °C (70 F). A third comparative example includes 1 ounce of tapioca and 1 ounce of cold brew tea material in 44 milliliters of the liquid beverage base having a temperature of 21.11 °C (70 F). A fourth comparative examples includes 1.30 ounces of rice and 1 ounce of cold brew tea material in 44 milliliters of the liquid beverage base having a temperature of 21.11 °C (70 F). A fifth comparative example includes 1 ounce of extra fine granulated sugar and 1 ounce of cold brew tea material in 44 milliliters of the liquid beverage base having a temperature of 21.11 °C (70 F). The total dissolved solid amount for the different comparative samples and also the control sample for Example 7 are summarized below in Table 10. The Brix values for the different comparative samples and also the control sample for Example 7 are summarized below in Table 10. The color values for the different comparative samples and also the control sample for Example 7, as measured using a honey color portable photometer (i.e., HANNA© Instruments Honey Color Portable Photometer HI96785), are also summarized below in Table 10.

TABLE 10
Comparative Examples

| | Total Dissolved | | | | | |
|---|---|---|---|---|---|---|
| Pouch | Solids (ppm) | | Brix | | Color | |
| Contents | 5 min. | 8 min. | 5 min. | 8 min. | 5 min. | 8 min. |
| Tea | 114 | 333 | 0 | 0 | 11 | 45 |
| Gravel | 222 | 367 | 0 | 0 | 32 | 47 |
| Tapioca | 285 | 400 | 0 | 0 | 36 | 53 |
| Rice | 311 | 443 | 0 | 0 | 44 | 65 |
| Sugar | 401 | 466 | 1.7 | 1.8 | 61 | 73 |

### Example 9

Comparative examples were prepared including pearl sugar as commercially available from WAFFLE PANTRY™. The pearl sugar was prepared by passing the material through a series of sieves (e.g., U.S. sieve sizes 18, 25, 35, 50, 80, 100, and 120) to confirm particle size. TABLE 11 summarizes the amount of pearl sugar retained by each sieve.

TABLE 11
Pearl Sugar Particle Size Confirmation

| Mesh/Sugar | Amount | % of Total |
|---|---|---|
| Particle Size | Retained | Weight |
| 12.7 mm | 0 oz | 0% |
| 9.51 mm | 0 oz | 0% |
| 8 mm | 0.286 oz | 7% |
| US 4 | 2.863 oz | 72% |
| US 8 | 0.585 oz | 15% |
| 12.7 mm | 0.1743 oz | 4% |
| Catch | 0.08715 oz | 2% |
| Total Weight | 4 oz | — |

An average particle size of the pearl sugar was determined by dividing each amount by the total sample weight minus the small amount retained in the catch to determine a weight fraction, multiplying the weight fraction by the relevant sieve size to determine a particle size fraction, and adding the individual particle size fractions to get an average particle size. For example, the pearl sugar may have an average particle size of about 4.527 millimeters.

A sample was prepared including about 0.5 ounces of cold brew tea leaves (as removed from commercially available LIPTON® Cold Brew Ice Black Tea) mixed with 7.25 ounces of the pearl sugar. The sample was added to a mesh pouch that was 15.24 millimeters (6 inches) by 15.24 millimeters (6 inches) and formed from nonwoven polylactic acid fabrics to form a water-permeable pouch.

The water-permeable pouch was freely placed in a beverage container/storage vessel. The beverage container was a cylindrical pitcher. The respective beverage container was filled with 1760 milliliters (59.5 fluid ounces) of a beverage base (e.g., water) having a temperature of about 18.9 °C (66 F), an example of a cold brew beverage temperature. The individual water-permeable pouch maintained contact with the beverage base for a total of about 40 minutes. Upon removal of the water-permeable pouch from contact with the beverage base at about 40 minutes, a Brix value was obtained for the beverage base using a commercially available Brix refractometer. A final beverage base temperature was also taken. There was about a 2-degree temperature decrease noted for the sample. The water-permeable pouch was also briefly removed from contact with the beverage base at about 10 minutes, about 20 minutes, about 25 minutes, about 30 minutes, and about 35 minutes to test the Brix values for the sample. The Brix values for the sample are summarized below in TABLE 12.

TABLE 12
Pearl Sugar Comparative Example

| Time | Brix |
|---|---|
| 10 mins | 8.8 |
| 20 mins | 10.6 |
| 25 mins | 10.8 |
| 30 mins | 10.8 |
| 35 mins | 10.8 |
| 40 mins | 10.8 |

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cold brew beverage product comprising:
a water-permeable container; and
a blend comprising a cold brew tea material and a solid sugar material disposed in the water-permeable container, the blend having less than or equal to about 30 weight % of the cold-brew tea material and greater than or equal to about 70 weight % of the solid sugar material based on a total weight of the blend, the cold brew tea material configured to steep in a liquid base comprising water having a temperature of less than or equal to about 50 °C and the solid sugar material comprising particulates having particle sizes of greater than or equal to about U.S. 30 mesh sieve.

2. The cold brew beverage product of claim 1, wherein the blend fills greater than or equal to about 50 vol. % of a total interior volume defined by the water-permeable container.

3. The cold brew beverage product of claim 1, wherein the solid sugar material is selected from the group consisting of: glucose, fructose, galactose, sucrose, lactose, maltose, and combinations thereof.

4. The cold brew beverage product of claim 1, wherein the water-permeable container has at least one dimension greater than or equal to about 15 millimeters and the water-permeable container comprises a material selected from the group consisting of: nylon, polyester, polypropylene, polyethylene, polylactic acid, cotton, cellulose, and combinations thereof.

5. The cold brew beverage product of claim 1, wherein the solid sugar material is a first solid sugar material and the blend further comprises a second solid sugar material, the second solid sugar material comprising one or more of:
(i) particulates having particle sizes greater than or equal to about U.S. 25 mesh sieve;
(ii) particulates having particle sizes greater than or equal to about U.S. 20 mesh sieve;
(iii) particulates having particle sizes greater than or equal to about U.S. 18 mesh sieve;
(iv) particulates having particle sizes greater than or equal to about U.S. 16 mesh sieve;
(v) particulates having particle sizes greater than or equal to about U.S. 14 mesh sieve;
(vi) particulates having particle sizes greater than or equal to about U.S. 12 mesh sieve;
(vii) particulates having particle sizes greater than or equal to about U.S. 10 mesh sieve; or
(viii) particulates having particle sizes greater than or equal to about U.S. 8 mesh sieve.

6. The cold brew beverage product of claim 5, wherein the blend comprises greater than or equal to about 50 weight percent of the first solid sugar material based on the total weight of the blend and greater than or equal to about 50 weight percent of the second solid sugar material based on the total weight of the blend.

7. The cold brew beverage product of claim 1, wherein the cold brew beverage product consists of the water-permeable container and the blend, the blend consisting of the tea material and the solid sugar material, and the solid sugar material consisting of the particulates having particle sizes greater than or equal to about U.S. 30 mesh sieve.

8. The cold brew beverage product of claim 1, wherein the cold brew beverage product consists of the water-permeable container and the blend, the blend consisting of the tea material and the solid sugar material and wherein:
(i) the solid sugar material consists of the particulates having particle sizes greater than or equal to about U.S. 25 mesh sieve;
(ii) the solid sugar material consists of the particulates having particle sizes greater than or equal to about U.S. 20 mesh sieve;
(iii) the solid sugar material consists of the particulates having particle sizes greater than or equal to about U.S. 18 mesh sieve;
(iv) the solid sugar material consists of the particulates having particle sizes greater than or equal to about U.S. 16 mesh sieve;
(v) the solid sugar material consists of the particulates having particle sizes greater than or equal to about U.S. 14 mesh sieve;
(vi) the solid sugar material consists of the particulates having particle sizes greater than or equal to about U.S. 12 mesh sieve;
(vii) the solid sugar material consists of the particulates having particle sizes greater than or equal to about U.S. 10 mesh sieve; or
(viii) the solid sugar material consists of the particulates having particle sizes greater than or equal to about U.S. 8 mesh sieve.

9. The cold brew beverage product of claim 1, wherein the cold brew tea material comprises a tea powder and tea leaves.

10. The cold brew beverage product of claim 9, wherein the cold brew tea material comprises the tea powder at greater than or equal to 1 weight % to less than or equal to about 10 weight % with a balance being the tea leaves.

11. The cold brew beverage product of claim 1, wherein the cold brew tea material is configured to steep in the liquid base comprising water having a temperature of less than or equal to about 50 °C for less than or equal to about 20 minutes and form a cold brew beverage product having total dissolved solids of greater than or equal to about 200 parts per million and a Brix sugar content of greater than or equal to about 7.

12. The cold brew beverage product of claim 1, wherein the blend includes less than or equal to about 20 weight % of the cold-brew tea material and greater than or equal to about 80 weight % of the solid sugar material based on a total weight of the blend.

13. A method for preparing a cold brew beverage, the method comprising:
contacting a cold brew beverage product with a liquid base in a container having a temperature less than or equal to about 50 °C, the cold brew beverage product comprising:
a water-permeable container; and
a blend of a cold brew tea material and a solid sugar material disposed in the water-permeable container, the blend comprising less than or equal to about 20 weight percent of the tea material and greater than or equal to about 80 weight percent of the solid sugar material based on the total weight of the blend, and the solid sugar materials comprising sugar particulates having particle sizes greater than or equal to about U.S. 30 mesh sieve; and
steeping the cold brew tea material in the liquid base in the container for a duration of less than or equal to about 25 minutes to form the cold brew beverage having total dissolved solids of greater than or equal to about 200 parts per million and a Brix sugar content of greater than or equal to about 7.

14. The method of claim 13, where the temperature is greater than or equal to about 5 °C.

15. The method of claim 13, wherein the cold brew beverage product is freely disposed in the container.

16. The method of claim 15, wherein during the steeping, the cold brew beverage product sinks to the bottom of the container and subsequently rises to the top of the container as a portion of the solid sugar material dissolves in the liquid base.

17. The method of claim 13, wherein the contacting comprises either:
disposing the cold brew beverage product and the liquid base in the container concurrently;
disposing the cold brew beverage product in the container and subsequently introducing the liquid base into the container; or
introducing the liquid base into the container and subsequently disposing the cold brew beverage product in the container.

18. The method of claim 13, wherein the duration is greater than or equal to about 5 minutes to less than or equal to about 20 minutes.

19. The method of claim 13, wherein the temperature of the liquid base is not increased during the steeping.

20. The method of claim 13, wherein the cold brew beverage has total dissolved solids of greater than or equal to about 400 parts per million and a Brix sugar content of greater than or equal to about 10.
